(19) United States
(12) Patent Application Publication
(10) Pub. No.: US 2026/0007101 A1
(43) Pub. Date: Jan. 8, 2026

(54) SELF-PROPELLED FORAGE HARVESTER

(71) Applicant: CLAAS Selbstfahrende Erntemaschinen GmbH, Harsewinkel (DE)

(72) Inventors: Dennis Neitemeier, Lippetal (DE); Sven Carsten Belau, Gütersloh (DE); Ingo Bönig, Gütersloh (DE); Markus Brune, Harsewinkel (DE); Daniel Titkemeier, Osnabrück (DE); Matthis Dirksen, Warendorf (DE)

(73) Assignee: CLAAS Selbstfahrende Erntemaschinen GmbH, Harsewinkel (DE)

(21) Appl. No.: 19/257,787

(22) Filed: Jul. 2, 2025

(30) Foreign Application Priority Data
Jul. 2, 2024 (DE) 10 2024 118 781.6

(51) Int. Cl. A01D 43/08; G06V 10/764; G06V 10/82; G06V 20/10; G06V 20/52

(52) U.S. Cl. CPC A01D 43/085; G06V 10/764; G06V 10/82; G06V 20/188; G06V 20/52

(57) ABSTRACT

A self-propelled forage harvester. The forage harvester comprises a height-adjustable front attachment for collecting harvested material, work units for processing the harvested material, a transfer device for discharging the processed harvested material, a camera system for capturing images of a flow of harvested material passing through the forage harvester, an image evaluation device for evaluating the images, and a driver assistance system for actuating the front attachment, the work units and the transfer device. The image evaluation device is configured to continuously analyze the images of the flow of harvested material using a machine learning algorithm for a proportion of in particular inorganic contaminants contained in the flow of harvested material and to transmit a degree of contamination derived therefrom to the driver assistance system, which may autonomously adapt setting(s) of the front attachment and/or at least one of the work units depending on the degree of contamination.

### CROSS REFERENCE TO RELATED APPLICATION

This application claims priority under 35 U.S.C. § 119 to German Patent Application No. DE 10 2024 118 781.6 filed Jul. 2, 2024, the entire disclosure of which is hereby incorporated by reference herein. U.S. Pat. No. ______ (attorney docket no. 15191-25010A (P05852/8)) is incorporated by reference herein in its entirety.

### TECHNICAL FIELD

The present invention relates to a self-propelled forage harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2022/0284698 A1, incorporated by reference herein in its entirety, discloses a self-propelled harvester. The self-propelled harvester comprises a height-adjustable attachment arranged or positioned on a feed device for collecting harvested material, one or more work units for processing the picked-up or collected harvested material, a transfer device for discharging the processed harvested material, a camera system for capturing images of a flow of harvested material passing through the forage harvester, and an image evaluation device for evaluating the images. The camera system generates or records images of a flow of harvested material passing through the forage harvester are recorded, with the images being evaluated by the image evaluation device. The evaluation may be based on the determination of particle with an excess length of particles contained in the images. Based on the detected particles with excess length, the computing unit sets an operating parameter of a work unit of the forage harvester in order to achieve a predetermined theoretical cutting length of the crop.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic example of a self-propelled forage harvester.

FIG. 2 illustrates a schematic exemplary structure of an automatic setting machine of the forage harvester.

FIG. 3 illustrates an exemplary schematic representation of an image evaluation device.

FIG. 4 illustrates an alternate exemplary schematic representation of an image evaluation device.

FIG. 5 illustrates an example of an image segmented by a neural network using a hybrid algorithm according to FIG. 4.

### DETAILED DESCRIPTION

As discussed in the background, particle lengths in the harvested material may be determined. When the harvested material is collected by the front attachment, additional contaminants adhering to the harvested material or, if the distance to the soil is too small, contaminants picked up or collected by the front attachment itself may enter the flow of harvested material passing through the forage harvester. The degree of contaminants may detrimentally affect the further use of the processed harvested material. For example, when harvesting green fodder, contaminants contained therein may cause noxious fermentation of the silage or cause disease in the animals to which the green fodder is fed. This may thus be accompanied by financial losses.

Thus, in one or some embodiments, a self-propelled forage harvester is disclosed which may comprise a more efficient actuation of the front attachment and work units in order to reduce, to avoid or to at least minimize contaminants from being collected, or to reduce the influence of picked up contaminants on the harvested material processing process.

In one or some embodiments, the self-propelled forage harvester comprises a front attachment arranged or positioned on a feed device in a height-adjustable manner and configured to pick up or collect harvested material, one or more work units configured to process the picked-up or collected harvested material, a transfer device configured to discharge the processed harvested material, a camera system configured to acquire one or more images of a flow of harvested material passing through the forage harvester, an image evaluation device configured to evaluate the one or more images, and a driver assistance system configured to actuate or control any one, any combination, or all of the front attachment, the one or more work units and the transfer device. The driver assistance system may include a memory for saving data and a computing device for processing the data saved in the memory. In one or some embodiments, any one, any combination, or all of the image evaluation device, the driver assistance system, the front attachment, and the work unit(s) may form an automatic adjustment machine, in that the image evaluation device is configured to analyze (such as continuously analyze) the images of the flow of harvested material using a machine learning algorithm for a proportion (or degree) of particular inorganic contaminant(s) contained in the flow of harvested material (with the images being recorded when the harvested material is collected by the front attachment), and to transmit a proportion of contamination derived therefrom (or an indication of the proportion, such as the degree, or other type of indication that is derived based on the proportion) to the driver assistance system. In turn, the driver assistance system may autonomously and/or continuously adapt or control setting(s) of the front attachment and/or the one or more work units depending on the proportion of contamination (or based on the indication of the proportion, such as the degree, or other type of indication of the proportion).

In one or some embodiments, inorganic contaminants in the harvested material may be caused, among other things, by the setting(s) of the front attachment on the forage harvester and/or the setting(s) of the work units that perform the harvesting process. In one particular example, inorganic contaminants may be introduced into the harvested material to be collected due to parameters or settings of the front attachment that may not be optimally set.

In one or some embodiments, the machine learning algorithm may automatically analyze the proportion of inorganic contaminant(s) contained in the flow of harvested material, with the at automatic analysis being performed at least partly during the ongoing harvesting operation (as the crop is being harvested). In this regard, it is contemplated to economically qualify and/or quantify a proportion (or a degree) of contamination of the harvested material. In particular, the analysis may be performed in real time for one or more types of flows of harvested material. For example, the flow of harvested material is a green forage flow of harvested material.

The automatic setting unit formed by one or more of the image evaluation device together with the driver assistance system, the front attachment and the work units may enable an operator of the forage harvester to autonomously adapt settings made by the operator for the front attachment and/or the attachments to the degree of contamination of the harvested material determined using the machine learning algorithm, with the dynamic control being perform at least partly during the forage harvester performing the harvesting process.

The work units, which may be automatically actuated by the driver assistance system of the automatic setting unit, may comprise any one, any combination, or all of the feed device, a chopping device with a rotationally driven cutterhead with chopping blades and a shear bar for comminuting the harvested material, a drum bottom arranged or positioned between the shear bar and an discharge channel with a variable distance relative to the cutterhead, as a post-accelerator, and as a silage additive metering device.

In particular, the image evaluation device may comprise a computing unit and a memory unit, wherein a plurality of contamination classes (e.g., potential contamination classes) are saved in the memory unit, which may define different degrees of contamination which may be dependent on the mass content of inorganic contaminants, such as sand, earthy components (e.g., humus soil or other soil components) in the dry mass of the harvested material. The machine learning algorithm may comprise at least one trainable neural network configured to analyze the one or more images. Further, the at least one neural network may comprise an EfficientNet, such as EfficientNetB0, as the architecture and scaling method for convolutional neural networks. Neural convolutional networks or convolutional neural networks (CNN), such as EfficientNet, may achieve particularly good results in image processing. EfficientNet may scale some or all dimensions of depth/width/resolution uniformly with a composite coefficient. In contrast to the conventional practice of using a convolutional neural network in which these factors are scaled arbitrarily, the EfficientNet scaling method may scale the network width, depth and/or resolution uniformly with a series of fixed scaling coefficients. The composite scaling method may be warranted in that with a larger input image, the network may need more layers to enlarge the receptive field and more channels to record more fine-grained patterns on the larger image.

In this case, a distinction may be made between five degrees of contamination which may result from the ratio of the mass content of inorganic contaminants to the dry mass of the harvested material. In particular, the sand content, the proportion of earthy components (such as humus soil and/or another indicator representative of soil material as a contamination in the harvested material) may be determined in order to qualify the degree or proportion of contamination. In one or some embodiments, a contamination class may be assigned to each degree of contamination.

To minimize contaminants from being picked up, the automatic setting unit may be configured to adjust one or more setting parameters, such as any one, any combination, or all of: the distance of the front attachment to the field soil; the contact pressure on the field soil; or performing a transverse and/or longitudinal adjustment of the front attachment relative to the field soil.

Alternatively or additionally, in order to minimize picking up contaminants, the automatic setting unit may be configured to adjust a drive speed of at least one material-conveying component of the front attachment. The type and design of a material conveying component may depend on the design of the front attachment and thus may correspondingly vary.

The reduction or minimization of picking up or collecting contaminants with the harvested material, which may be performed by the automatic setting unit actuating or controlling the front attachment, may be based on the fact that fewer contaminants are picked up by the front attachment (along with the harvested material) as a result of the mentioned automatic control.

In one or some embodiments, the automatic setting unit may be configured to adjust a pre-compression force exerted on the harvested material by pairs of prepress rollers of the feed device in response to collected harvested material being contaminated with contaminants and/or depending on the degree or proportion of contamination.

Alternatively or additionally, the automatic setting unit may be configured to adjust the cutting length of the chopping device in response to harvested material collected with contaminants and depending on the degree or proportion of contamination.

by the front attachment the automatic setting unit may be configured to adjust a distance between the drum bottom and the cutterhead and/or a distance between the post-accelerator and the wall of the discharge chute in response to the collected harvested material being contaminated with contaminants and depending on the degree or proportion of contamination.

Alternatively or additionally, the automatic setting unit may be configured to actuate a liquid delivery of the silage additive metering device. The silage additive metering device may comprise at least one tank, which may also be filled with just water. In response to collected harvested material being contaminated with contaminants and depending on the degree or proportion of contamination, the automatic setting unit may actuate the silage additive metering device to inject water into the discharge channel in order to control (such as reduce) the degree or proportion of contamination.

The automatic setting unit controlling or actuating the one or more work units in response to collected harvested material contaminated with contaminants and/or depending on the degree or proportion of contamination is based on controlling the amount of contamination in the collected harvested material, such as reducing the contaminants in the collected harvested material (e.g., keeping the contaminants in the flow of material as low as possible). In one or some embodiments, the control may result in the flow of material being kept at a predetermined uniform level (e.g., the amount of contaminants in the flow of material is at (or no greater than) a predetermined degree or proportion).

In one or some embodiments, the at least one neural network may use a direct algorithm to analyze the one or more images received from the camera system. In practice, the one or more images may be input to the at least on neural network in raw data format, wherein the at least on neural network may perform the classification, and wherein the at least on neural network may determine one of the contamination classes as an output variable. The direct algorithm used by the neural network may directly process the one or more images of the camera system (e.g., without preprocessing by semantic segmentation) in order to perform the classification with which one of the contamination classes is determined as the output variable of the at least on neural network.

In one or some embodiments, the at least one neural network may use a hybrid algorithm to analyze the one or more images received by the camera system, which may input, as input variables, the images in raw data format. The at least one neural network may analyze the input images for semantic segmentation, and generate one or more features extracted from the pixel-by-pixel segmented images as output variables. In turn, the one or more features extracted from the pixel-by-pixel segmented images may be input to a second neural network as input variables, with the second neural network determining one or more of the contamination classes from the extracted one or more features. In turn, the determined one or more contamination classes may be output by the second neural network an output variable.

For this purpose, the at least one neural network may segment the images received from the camera system pixel-by-pixel in that a class may be assigned to each pixel, which may be defined as a property saved in the memory unit.

The property “soil” may be saved as one class, and the property “harvested material” may be saved as another class. In one or some embodiments, a reduction to just two properties may simplify the process of semantic segmentation by the at least one neural network.

In particular, extracted features saved in the memory unit may be from any one, any combination, or all of: segmentation ratio; number of polygons; average polygon size; standard deviation of the polygon size distribution; smallest polygon size; or largest polygon size. For this purpose, polygons in the pixel-by-pixel segmented image that contain segmented pixels of the “soil” class may be determined using a contour search algorithm.

In one or some embodiments, the second neural network may be a neural network with an input layer, one or more hidden layers, and an output layer.

In particular, the at least one neural network may evaluate at least three consecutively received images of the flow of harvested material for the determination of the contamination class, wherein the results may be output as a weighted average value. This may allow a statistically robust output value to be generated, regardless of whether the direct algorithm or the hybrid algorithm is used.

Furthermore, one of the at least three consecutive images of the flow of harvested material for which the contamination class is to be determined may be selected, wherein the selected image may have a higher weighting than the at least two other images when averaging. For example, the selected image may be weighted with 40%, and the other two images may be weighted with 30%. In one or some embodiments, the selected image is the second image of the three images taken sequentially in chronological order.

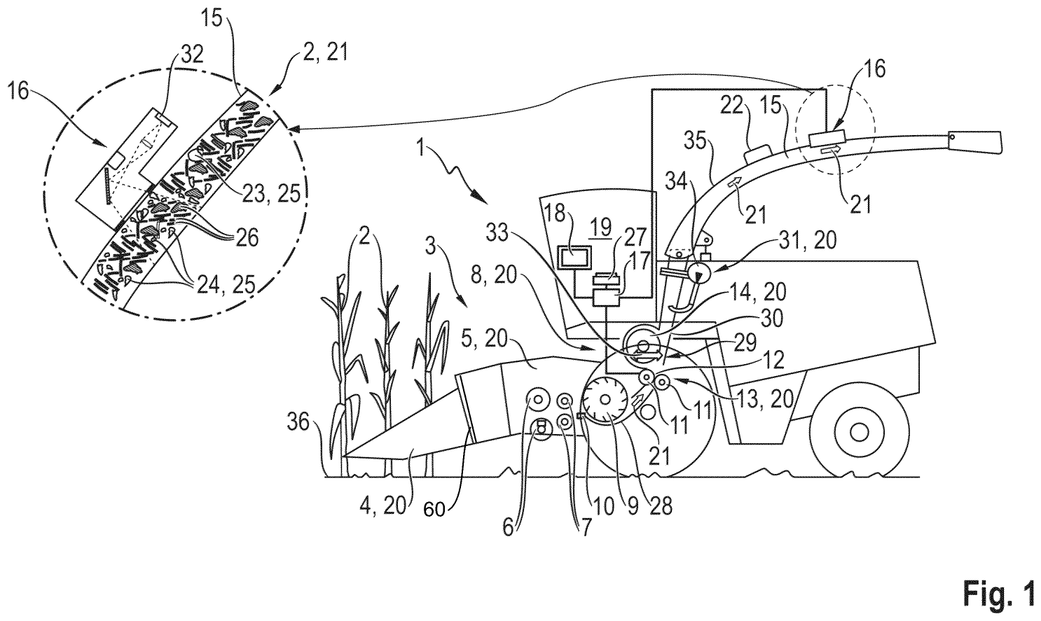

Referring to the figures, FIG. 1 schematically illustrates a self-propelled forage harvester 1. Examples of forage harvesters are disclosed in US Patent Application Publication No. 2024/0196796 A1, US Patent Application Publication No. 2024/0237580 A1, US Patent Application Publication No. 2025/0072326 A1, each of which are incorporated by reference herein in their entirety. FIG. 1 illustrates harvesting and collecting a crop of harvested material 2, such as corn plants, grass or whole plant silage as green fodder, in a field. Pick-up device 3 of the forage harvester 1 comprises, in a known manner, a front attachment 4 that may be exchanged to adapt to the harvested material 2 to be harvested or collected and a feed device 5 with several pairs of rollers 6, 7 (e.g., prepress or preconditioning rollers), which may take the harvested material 2 from the attachment 4 in order to feed it to a chopping device 8. In one or some embodiments, the attachment 4 may be mounted directly to the harvester 1 (via a mounting device 60 on harvester 1) or via an adapter that connects the harvester 1 to the attachment 4. See US Patent Application Publication No. 2024/0196796 A1. As one example, the mounting device 60 may include any one, any combination, or all of bolts, clamps, or fasteners that may be resident on one of the mounting device 60 with mating attachments (e.g., holes, clamps, or the like) resident on the attachment 4. The picked up or collected harvested material 2 then passes through the forage harvester 1 as a flow of harvested material 21, illustrated by arrows.

The front attachment 4 may, for example, be designed as a corn attachment to harvest stalky crops 2 or as a pick-up which picks up crops 2, such as grass, deposited in swaths in the field. The front attachment 4 may also have a cutter bar with a feed auger to mow and pick up grass in a single pass.

The chopping device 8 may comprise a rotationally driven cutterhead 9, a shear bar 10 over which the harvested material 2 is pushed by the adjacent pair of rollers 7 of the feed device 5 in order to be chopped by the interaction of the shear bar 10 with the cutterhead 9. Using an actuator, a distance of a drum bottom 28 (or drum base), which may partially surround the cutterhead 9 in the circumferential direction, may be adjusted.

An optional secondary crushing device 13, also known as a corn cracker, with a pair of conditioning or cracker rollers 11 may be arranged or positioned downstream from the chopping device 8, which may be removed and/or swung out in the ejection channel 29 (or discharge channel). The conditioning rollers 11 delimit a gap 12 of adjustable width and rotate at different speeds in order to crush grains contained in the material stream passing through the gap 12.

A post-accelerator 14 may give the shredded flow of harvested material 21 conditioned in the optional secondary crushing device 13 the necessary speed to pass through a transfer device that comprises a discharge chute 15 and to be transferred into an accompanying vehicle (not shown). The post-accelerator 14 may be arranged or positioned at a variable distance from the opposite wall 30 of the ejection channel 29. The post-accelerator 14 may be moved closer to or further away from the wall 30 in the horizontal direction, which is illustrated by arrow 33.

A silage additive metering device 31 may be arranged or positioned downstream from the post-accelerator 14, which may introduce a liquid into the ejection channel 29 using a controllable or actuatable feed pump 34 with a variable delivery volume.

In one or some embodiments, the discharge chute 15 has an essentially rectangular cross-section along its lengthwise extension. The discharge chute 15 may have a continuous closed upper side 35 and a partially open underside. Side walls may be arranged or positioned orthogonally to the upper side 35 of the discharge chute 15, which may laterally delimit and guide the flow of harvested material 21 conveyed through the discharge chute 15.

At least one camera system 16 is arranged or positioned on the discharge chute 15 in order to generate images 41 of the flow of harvested material 21 conveyed through the discharge chute 15. Furthermore, a sensor, such as an NIR sensor 22, may be arranged or positioned on the discharge chute 15. The NIR sensor 22 may be used to generate data, which when analyzed, may determine the harvested material properties. In one or some embodiments, the NIR sensor 22 may be positioned here upstream from the camera system 16 on the upper side 35 of the discharge chute 16.

Thus, work units 20 of the forage harvester 1 may comprise any one, any combination, or all of: the front attachment 4; the intake device 5; the chopping device 8; the secondary crushing device 13; the post-accelerator 14; or the silage additive metering device 31 and their given components. The work units 20 may be used for harvesting or picking up the harvested material 2 of a field crop and/or for processing the harvested material 2 as part of the harvesting process.

The flow of harvested material 21 processed by the work units 20 of the forage harvester 1 may have a different composition depending on the type of harvested material. For example, in the case of corn as the harvested material type, the flow of harvested material 21 basically contains whole grains 23 and comminuted grains 24 as grain components 25 as well as non-grain components 26 such as stalks, leaves and the like. With grass as the type of harvested material, the flow of harvested material 21 basically contains only cut grass as harvested material 2.

In addition, contaminants adhering to the harvested material 2 may pass through the front attachment 4 with the picked up harvested material 2 or, if the distance to the field soil 36 is too small, contaminants picked up by the front attachment 4 itself may enter the flow of harvested material 21 passing through the forage harvester 1. Contaminants adhering to the harvested material 2 may be caused, among other things, by a previous processing operation in the field (e.g., an operation that was performed prior to the forage harvester 1 even collecting the harvested material 2). In the case of grass harvesting, examples of this may include mowing, turning and swathing.

In one or some embodiments, at least a part of at least one camera system 16 may be arranged or positioned on the discharge chute 15. For example, the at least one camera system 16 may have at least one camera 32 for recording images 41 of the harvested material 2 contained in the flow of harvested material 21. The camera 32 may be positioned on discharge chute 15. The camera 32 may comprise a multispectral camera which records the light with at least three distinguishable wavelength ranges. Alternatively, the camera 32 may comprise a hyperspectral camera. In particular, the camera 32 may record visible light and infrared light, such as near-infrared light, from different wavelength ranges.

The images 41 may be saved in raw data format. For example, the at least one camera 32 may record spatially resolved images 41. The term “spatially resolved” may mean that it is possible to distinguish details of the harvested material 2 and contaminants from one another using the images 41. The camera 32 therefore may have a sufficient number of pixels to enable an analysis of the images 41 by the image evaluation device 27, as will be explained. In a measurement routine, the camera system 16 (using the camera 32) may capture a plurality of images 41 of the harvested material 2 as well as the contaminants entrained in the flow of harvested material 21. This measurement routine may accordingly be performed at least partly during operation of the forage harvester 1 (e.g., in order to dynamically control the forage harvester 1 or its front attachment 4 while the forage harvester is operating).

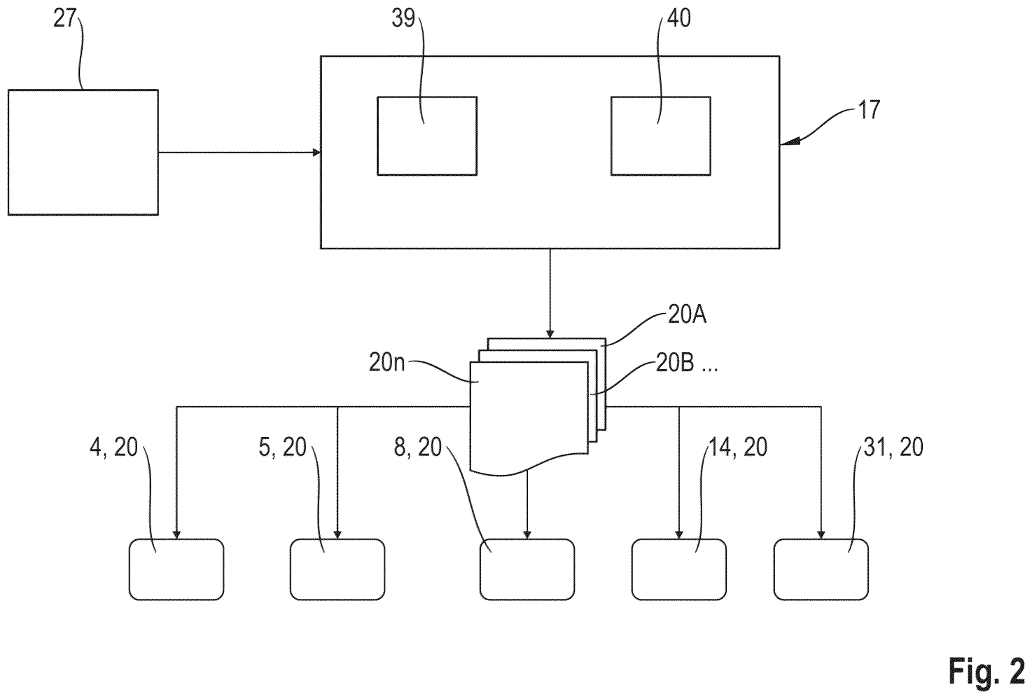

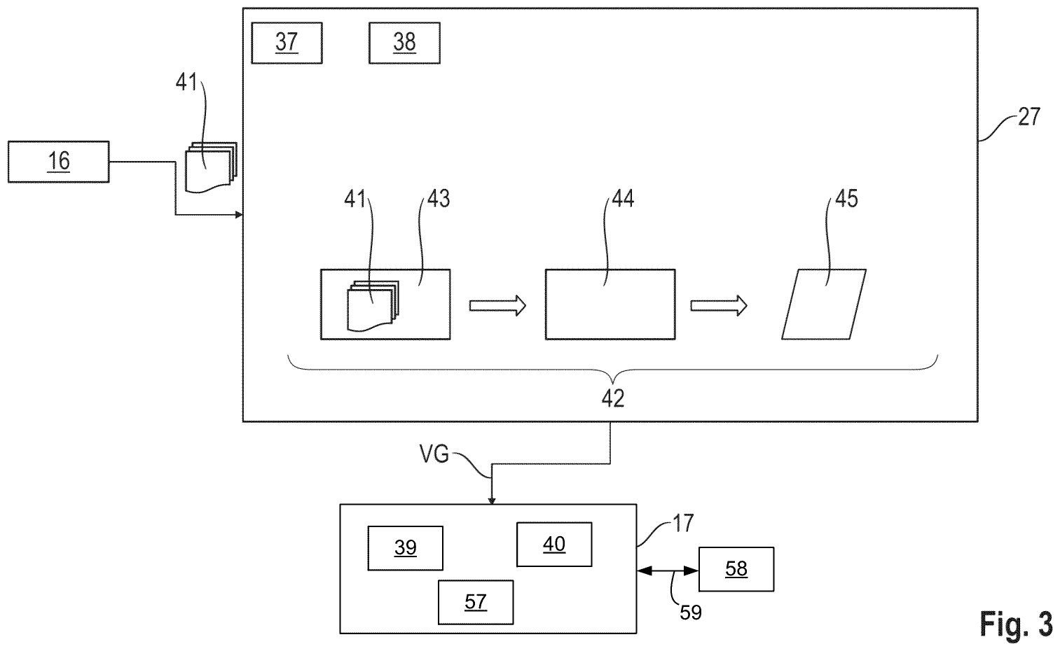

FIG. 2 illustrates a schematic exemplary structure of an automatic setting machine of the forage harvester 1. In one or some embodiments, the image evaluation device 27 is in communication with (e.g., bi-directional communication) a driver assistance system 17, or may be designed as a component of the driver assistance system 17. The driver assistance system 17 may include a memory unit 39 for saving data and a computing device 40 for processing the data saved in the memory unit 39. The driver assistance system 17 may be connected to an input/output unit 18 (e.g., a touchscreen) in a driver's cab 19 of the forage harvester 1 in order to output evaluation results thereto. The driver assistance system 17 may be configured to control at least one actuator 20A, 20B, . . . 20n (in FIG. 2) or 58 in FIG. 3 (via wired and/or wireless communication 59) for adjusting, modifying or controlling one or more of the work units 20.

In one or some embodiments, the computing device 40 may comprise at least one processor and the memory unit 39 may comprise at least one memory (configured to store data, such as image(s), machine learning algorithm(s), neural network(s), and/or computer-executable instructions stored on the tangible memory). The driver assistance system 17 may further include at least one communication interface 57 (configured to communication with devices external to the driver assistance system 17, such as actuators 58, other electronic devices, or the like). The at least one processor and at least one memory may be in communication (e.g., wired and/or wirelessly) with one another. In one or some embodiments, the computing device 40 may comprise a microprocessor, controller, PLA, or the like. Similarly, the memory unit 39 may comprise any type of storage device (e.g., any type of memory, such as RAM, ROM, or a combination thereof). Though the computing device 40 and the memory unit 39 are depicted as separate elements, they may be part of a single machine, which includes a microprocessor (or other type of controller) and a memory. Alternatively, the computing device 40 may rely on the memory unit 39 for all of its memory needs. Still alternatively, the computing device 40 may rely on a database for some or all of its memory needs. The memory unit 39 may comprise a tangible computer-readable medium that include software that, when executed by the computing device 40 is configured to perform any one, any combination, or all of the functionality described herein. Further, the communication interface 57 may be configured to communicate (e.g., wired and/or wirelessly) with one or more electronic devices.

The computing device 40 and the memory unit 39 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The image evaluation device 27, using a machine learning algorithm, may be configured to analyze the images 41 of the flow of harvested material 21 for a proportion of inorganic contaminants contained in the flow of harvested material 21, which may have been collected by the front attachment.

The image evaluation device 27 comprises a computing unit 37 (e.g., similar to computing device 40 discussed above) and a memory unit 38 (e.g., similar to memory unit 39 discussed above). Alternatively, image evaluation device 27 may be part of the driver assistance system 17. A plurality of contamination classes may be saved in the memory unit 38, that define different degrees of contamination VG, which may be dependent on the mass content of inorganic contaminants in the dry mass of the harvested material 2. Contaminants, such as inorganic contaminants, may comprise sand, earthy components such as humus soil, or other soil components.

Any one, any combination, or all of the driver assistance system 17, the front attachment 4, the work units 20 of the forage harvester 1, or the image evaluation device 27 may form an automatic setting machine. The image evaluation device 27 may be configured to analyze, such as continuously analyze, using the machine learning algorithm, the images 41 of the flow of harvested material 21 for a proportion or degree of the inorganic contaminants contained in the flow of harvested material 21 collected by the front attachment 4 when picking up the harvested material 2, and to transmit the degree or proportion of contamination VG derived therefrom to the driver assistance system 17. In turn, the driver assistance system 17 may be configured to autonomously and continuously adapt setting(s) of the front attachment 4 and/or one or more of the work units 20 depending on the determined degree of contamination VG. In this regard, the driver assistance system 17 may actuate one or more of the actuators 20A, 20B, . . . 20n based on the determined degree of contamination VG, such as in order to reduce the degree of contamination.

In one or some embodiments, actuators 20A, 20B, . . . 20n of the work units 20 may comprise linear actuators, through which a position of at least one of the work units 20 or at least one component of the work unit 20 and/or a force exerted on at least one of the work units 20 or at least one component is manipulated or modified. In one or some embodiments, actuators 20A, 20B, . . . 20n may furthermore be electric and/or hydraulic drive motors and/or mechanical drives whose drive speed and/or drive torque is adjustable, with which at least one of the work units 20 or at least one component of the work unit 20 is driven. Further, actuators 20A, 20B, . . . 20n, which may be actuated or controlled by the driver assistance system 17, may be hydraulic pumps, fluid pumps or the like. In this regard, responsive to the determined degree of contamination VG, the driver assistance system 17 may control one or more aspects of the work units 20.

The following table shows an exemplary classification according to Resch et. al. 2013 “Bedeutung des Eisengehaltes als Indikator fir die Futterverschmutzung von GrUnlandfuttermitteln” [Importance of iron content as an indicator of forage contamination in grassland forage]. In addition to the iron content, the proportion of sand contained in the dry matter of harvested material 2 is listed as an indicator of forage contamination. Other indicators may be earthy components such as humus soil or other soil components. A contamination class may be assigned to each degree of contamination VG.

TABLE

| Contamination | Degree of | | Sand content |
|---|---|---|---|
| class | contamination VG | Iron [mg/kg DM] | [g/kg DM] |
| 1 | Clean | Under 400 | Under 13 |
| 2 | Light | 400 to 800 | 13 to 19 |
| 3 | Moderate | 800 to 1500 | 19 to 30 |
| 4 | Strong | 1500 to 3000 | 30 to 53 |
| 5 | Very strong | Over 3000 | Over 53 |

The machine learning algorithm may comprise at least one trainable neural network 42 configured to analyze the images 41 of the flow of harvested material 21. In one or some embodiments, the at least one neural network 42 uses as a basis an EfficientNet, in particular EfficientNetB0, as an architecture and scaling method for convolutional neural networks.

FIG. 3 illustrates an example of a schematic representation of the image analysis device 27. According to the embodiment of the image evaluation device 27 illustrated in FIG. 3, the at least one neural network 42 uses a direct algorithm for analyzing the images 41 received from the camera system 16, which uses the images 41 in raw data format as an input variable 43, which may be subjected directly (e.g., without an intermediate step for semantic segmentation) to classification by the at least one neural network 42 in a classification step 44 and determine one of the contamination classes saved in the memory unit 38 as an output variable 45.

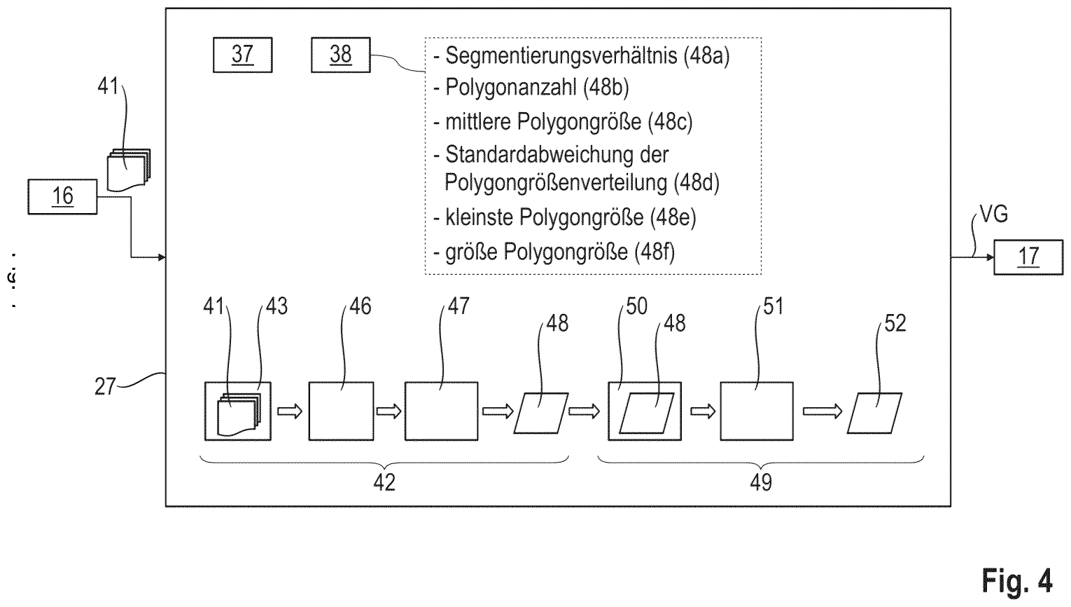

FIG. 4 illustrates a schematic representation of the image analysis device 27 according to an alternative embodiment. According to the alternative embodiment of the image evaluation device 27, the at least one neural network 42 uses a hybrid algorithm for analyzing the images 41 received from the camera system 16, which uses as an input variable 43 the images 41 received in raw data format which are subjected to a semantic segmentation by a segmentation model 46 by the neural network 42 and generates features 48 extracted from the pixel-wise segmented images 41a as an output variable. The features 48 of the neural network 42 generated as output variables may be fed to a second neural network 49 as input variables 50, which may determine one of the contamination classes (as potential contamination classes) saved in the memory unit 38 from the extracted features 48 in a classification step 51 as an output variable 52.

For this purpose, the neural network 42 segments the images 41 received from the camera system 16 pixel-by-pixel in that a class is assigned to each pixel 54, which may be defined as a property saved in the memory unit 38. For example, the property “soil” may be saved as one class 55, and the property “harvested material” may be saved as another class 56.

Extracted features 48 saved in the memory unit 38 may be from one or more features, such as any one, any combination, or all of the following feature group: segmentation ratio 48a; number of polygons 48b; average polygon size 48c; standard deviation of the polygon size distribution 48d; smallest polygon size 48e; and largest polygon size 48f. The polygons 53 may be determined for this purpose using a contour search algorithm 47, which may be executed by the neural network 42 in order to extract the features 48 therefrom from the aforementioned feature group.

The feature 48 “Segmentation ratio 48a” may describe the number of pixels 54 classified as “soil” in relation to the total number of pixels 54 in the pixel-wise segmented image 41a. The feature 48 “number of polygons 48b” may describe the number of areas classified as “soil”. The feature 48 “average polygon size 48c” may describe an average size of the polynomials 53. The feature 48 “smallest polygon size 48e” may indicate the number of pixels 54 of the class 55 of the smallest determined polygon 53. The feature 48 “largest polygon size 48f” may indicate the number of pixels 54 of the class 55 of the largest determined polygon 53.

In one or some embodiments, the second neural network 49 may be a neural network with an input layer, hidden layer(s) (e.g., only one hidden layer), and an output layer. The second neural network 49 may be designed as a simple neural network for the sole process of classification.

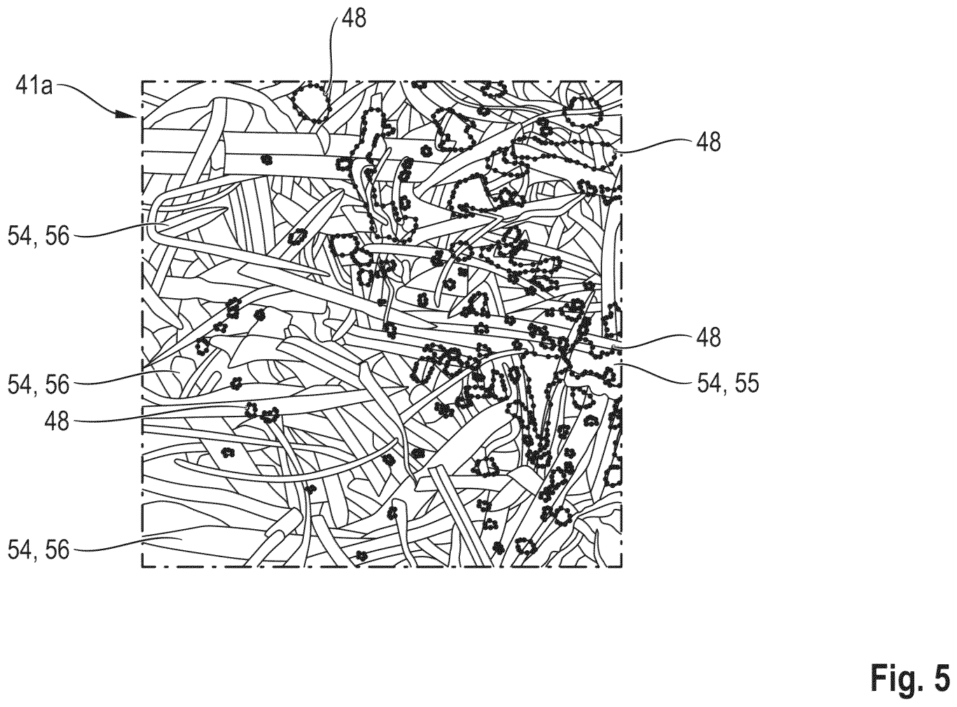

FIG. 5 illustrates an example of an image 41a segmented by the neural network 42 using the hybrid algorithm according to FIG. 4. The images 41 transmitted to the neural network 42 in raw data format as an input variable 43 may be segmented pixel-by-pixel by the segmentation model 46. Each segmented pixel 54 of the image 41a may be assigned either the class 55 with the property “soil” or the further class 56 with the property “crop”. The regions outlined in FIG. 5 may be contiguous areas of pixels 54 that have been assigned to class 55 with the property “soil”. Using the contour search algorithm 47, the polygons 53 may be determined based on the contiguous areas of pixels 54 that have been assigned to the class 55 with the property “soil”. The features 48 may be extracted from the determined polygons 53 as the output variable of the neural network 42.

The second neural network 49 may process the extracted features 48 as an input variable 50 in the classification step 51 and determine one of the contamination classes (saved in the memory unit 38) as an output variable 52.

The neural network 42 may be configured to evaluate at least three consecutively received images 41 of the flow of harvested material 21 to determine the contamination class, wherein the results may be output as a weighted average value. This may make it possible to generate a statistically robust output value for the output variable 45 or 52 (e.g., the assignment to one of the contamination classes listed in Table 1 and therefore to one of the degrees of contamination VG), irrespective of whether the direct algorithm, which may be executed by the neural network 42 alone, or the hybrid algorithm, which may be executed by the two neural networks 42 and 49, is used.

Furthermore, one of the at least three consecutive images 41 of the flow of harvested material 21 may be selected for which the contamination class is to be determined as the output variable 45 or 52, wherein the selected image 41 may have a higher weighting than the at least two other images 41 when averaging. For example, the selected image 41 may be weighted with 40% and the two other images 41 may be weighted with 30%. In one or some embodiments, the selected image 41 may be the second image of the three images 41 taken sequentially in chronological order.

The forage harvester 1 described above may be configured to perform the method for analyzing the contents in the harvested material 2. The harvested material 2 may be collected by the self-propelled harvester 1 with the front attachment 4, processed by the work units 20 of the forage harvester 1 and discharged by the discharge chute 15 of the transfer device. The images 41 of the flow of harvested material 21 passing through the forage harvester 1 may be captured by the camera system 16 arranged or positioned on the discharge chute 15 of the transfer device and evaluated by the image evaluation device 27. The proportion of inorganic contaminants contained in the flow of harvested material 21 may be analyzed using the machine learning algorithm using a direct or hybrid algorithm. The front attachment 4 and/or the work units 20 of the self-propelled harvester 1 may be automatically actuated (e.g., by the driver assistance system 17) depending on the degree of contamination VG that is automatically determined. For example, the driver assistance system 17 may be configured for this purpose, which may automatically receive the output variables 45 or 52 generated by the image analysis device 27 and may automatically generate one or more control signals therefrom for actuation (e.g., transmit the control signals via the communication interface 57 in order to control one or more of the work units 20, such as actuator(s) 58 of the work units 20).

In one or some embodiments, to reduce or minimize contaminants being collected by the front attachment 4, the automatic setting unit may be configured to adjust the distance of the front attachment 4 to the field soil 36 and/or the contact pressure on the field soil 36 and/or to perform a transverse and/or longitudinal adjustment of the front attachment 4 relative to the field soil 36.

Alternatively, or in addition, to minimize picking up contaminants, the automatic setting unit may be configured to adjust a drive speed of at least one material-conveying component of the front attachment. The reduction or minimization, by the automatic setting unit controlling the front attachment 4, of collecting contaminants with the harvested material 2 may be based on the fact that fewer contaminants are collected with the harvested material 2 by the front attachment 4 as a result of the mentioned measures.

For example, an inexperienced operator of the forage harvester 1 may unintentionally pick up soil material as contaminants with the harvested material 2 due to unadjusted settings of the front attachment 4. This circumstance may be countered by the automatic setting unit, which may be formed by the image evaluation device 27 together with the driver assistance system 17, the front attachment 4 and the work units 20.

Detection of contaminants in the harvested material 2 by the operator of the forage harvester 1 by simple visual inspection is generally not reliable as to the type and quantity of contaminants. Therefore, the automatic setting unit, with its analysis of the type and/or quantity of contaminants, may make it possible to collect fewer contaminants with the harvested material 2 by the front attachment 4 using the aforementioned measures. An example of this is the pick-up of harvested material 2 deposited in windrows. The degree of contamination VG may be influenced, among other things, by the preceding process steps, such as previously performing mowing, turning and swathing. In this regard, during the execution of the preceding process steps (e.g., process steps perform prior to performing the current operation with the forage harvester 1), the harvested material 2 may already become contaminated due to improper adjustment of the working machines that performed these preceding process steps required for this purpose before the forage harvester 1 even has collected the harvested material 2.

In one or some embodiments, the automatic setting unit may be configured to adjust a pre-compression force exerted on the harvested material 2 by pairs of prepress rollers 6, 7 of the feed device 5 in response to collected harvested material 2 being contaminated with contaminants and depending on the degree of contamination VG.

Moreover, in response to the determined degree of contamination VG, the automatic setting unit may be configured to adjust the cutting length of the chopping device 8.

In one or some embodiments, the automatic setting unit may be configured to adjust the distance between the drum bottom 28 and the cutterhead 9 and/or a distance between the post-accelerator 14 and the wall 30 of the ejection channel 29.

Furthermore, the automatic setting unit may be configured to actuate a liquid delivery of the silage additive metering device. The silage additive metering device 31 may comprise at least one tank which can also be filled with just water. In response to collected harvested material 2 contaminated with contaminants VG and depending on the degree of contamination, the automatic setting unit may actuate the silage additive metering device 31 and the feed pump 34 to inject water into the ejection channel 29.

The work units 20 by the automatic setting unit may be actuated in response to the collected harvested material being contaminated with contaminants. The actuation of the work units 20 by the automatic setting unit may depend on the degree of contamination VG in order to reduce or minimize the influence of the picked up harvested material 2 contaminated by contaminants on the flow of material. In one or some embodiments, the flow of material is kept as uniform as possible or at (or below) a predetermined level.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Harvester | 30 | Wall |
| 2 | Harvested material | 31 | Silage additive metering device |
| 3 | Pick-up device | 32 | Camera |
| 4 | Front attachment | 33 | Arrow |
| 5 | Feed apparatus | 34 | Feed pump |
| 6 | Prepress roller pair | 35 | Top side |
| 7 | Prepress roller pair | 36 | Field soil |
| 8 | Chopping device | 37 | Computing unit |
| 9 | Cutterhead | 38 | Memory unit |
| 10 | Shear bar | 39 | Computer device |
| 11 | Cracker roller | 40 | Memory |
| 12 | Gap | 41 | Images |
| 13 | Secondary crushing device | 41a | Segmented image |
| 14 | Postaccelerator | 42 | Neural network |
| 15 | Discharge chute | 43 | Input variable |
| 16 | Camera system | 44 | Classification step |
| 17 | Driver assistance system | 45 | Output variable |
| 18 | Input/output unit | 46 | Segmenting model |
| 19 | Driver's cab | 47 | Contour search algorithm |
| 20 | Work unit | 48 | Feature |
| 20A | Actuator | 48a | Segmentation ratio |
| 20A | Actuator | 48b | Number of polygons |
| 20n | Actuator | 48c | Average polygon size |
| 21 | Harvested material flow | 48d | Standard deviation of the polygon |
| | | | size distribution |
| 22 | NIR sensor | 48e | Smallest polygon size |
| 23 | Grains | 48f | Largest polygon size |
| 24 | Crushed grains | 49 | Second neural network |
| 25 | Grain components | 50 | Input variable |
| 26 | Non-grain components | 51 | Classification step |
| 27 | Image evaluation device | 52 | Output variable |
| 28 | Drum bottom | 53 | Polygon |
| 29 | Ejection channel | 54 | Pixel |
| 55 | Classified pixels | | |
| 56 | Classified pixels | | |
| 57 | Communication interface | | |
| 58 | Actuator | | |
| 59 | Communication | | |
| 60 | Mounting device | | |
| VG | Degree of contamination VG | | |

1. A self-propelled forage harvester comprising:
a mounting device configured to attach to a height-adjustable front attachment that is configured to collect harvested material;
one or more work units configured to receive or process the harvested material collected, the one or more work units comprising a feed device connected to or including the mounting device, the feed device configured to receive harvested material collected by the front attachment;
a transfer device configured to discharge the harvested material processed by the one or more work units;
at least one camera system configured to generate one or more images of a flow of the harvested material passing through at least a part of the forage harvester;
an image evaluation device configured to evaluate the one or more images; and
a driver assistance system configured to control one or more aspects of one or more of the front attachment, the one or more work units, or the transfer device;
wherein the image evaluation device is configured to:
analyze, using a machine learning algorithm, the one or more images of the flow of harvested material to determine a proportion of inorganic contaminants contained in the flow of harvested material; and
transmit, to the driver assistance system, the proportion of the inorganic contaminants or an indication of the proportion of the inorganic contaminants; and
wherein the driver assistance system, based on the proportion of the inorganic contaminants or the indication of the proportion of the inorganic contaminants, is configured to modify one or more settings of the front attachment or at least one of the one or more work units.

2. The forage harvester of claim 1, wherein the one or more work units comprise one or more of the feed device, a chopping device with a rotationally driven cutterhead with chopping blades and a shear bar for comminuting the harvested material, a drum bottom positioned between the shear bar and a discharge channel with a variable distance relative to the cutterhead, a post-accelerator, and a silage additive metering device.

3. The forage harvester of claim 1, wherein the image evaluation device comprises a computing unit and a memory unit;
wherein the memory unit is configured to save a plurality of contamination classes, the plurality of contamination classes defining different degrees of contamination which are dependent on a mass content of inorganic contaminants;
wherein the machine learning algorithm comprises at least one trainable neural network configured to analyze the one or more images; and
wherein the at least one neural network uses EfficientNet as architecture and scaling method for convolutional neural networks.

4. The forage harvester of claim 3, wherein the mass content of inorganic contaminants comprises iron, sand, humus soil or other soil components in dry mass of the harvested material.

5. The forage harvester of claim 1, wherein the driver assistance system, based on the proportion of the inorganic contaminants or the indication of the proportion of the inorganic contaminants, is configured to adjust one or more of:
adjust distance of the front attachment to field soil;
adjust contact pressure on the field soil; and
perform one or both of a transverse or longitudinal adjustment of the front attachment relative to the field soil.

6. The forage harvester of claim 1, wherein the driver assistance system, based on the proportion of the inorganic contaminants or the indication of the proportion of the inorganic contaminants, is configured to adjust a drive speed of at least one material-conveying component of the front attachment.

7. The forage harvester of claim 1, wherein the driver assistance system, based on the proportion of the inorganic contaminants or the indication of the proportion of the inorganic contaminants, is configured to adjust a precompression force exerted on the harvested material by pairs of precompression rollers of the feed device.

8. The forage harvester of claim 1, wherein the one or more work units comprise a chopping device with a rotationally driven cutterhead with chopping blades and a shear bar for comminuting the harvested material; and
wherein the driver assistance system, based on the proportion of the inorganic contaminants or the indication of the proportion of the inorganic contaminants, is configured to adjust a cutting length of the chopping device.

9. The forage harvester of claim 1, wherein the one or more work units comprise the feed device, a drum bottom positioned between a shear bar and a discharge channel with a variable distance relative to a cutterhead, and a post-accelerator; and
wherein the driver assistance system, based on the proportion of the inorganic contaminants or the indication of the proportion of the inorganic contaminants, is configured to adjust one or both of: a distance between the drum bottom and the cutterhead; a distance between the post-accelerator and a wall of the discharge channel.

10. The forage harvester of claim 1, wherein the one or more work units comprise the feed device and a silage additive metering device; and
wherein the driver assistance system, based on the proportion of the inorganic contaminants or the indication of the proportion of the inorganic contaminants, is configured to actuate a liquid delivery of the silage additive metering device.

11. The forage harvester of claim 1, wherein the image evaluation device comprises a computing unit and a memory unit;
wherein the memory unit is configured to save a plurality of contamination classes, the plurality of contamination classes defining different degrees of contamination which are dependent on a mass content of inorganic contaminants;
wherein the machine learning algorithm comprises at least one trainable neural network configured to analyze the one or more images;
wherein the at least one neural network is configured to:
receive the one or more images in raw data format as input;
subject the one or more images directly to a respective classification; and
determine one of the contamination classes as an output variable.

12. The forage harvester of claim 1, wherein the image evaluation device comprises a computing unit and a memory unit;
wherein the memory unit is configured to save a plurality of contamination classes, the plurality of contamination classes defining different degrees of contamination which are dependent on a mass content of inorganic contaminants;
wherein the machine learning algorithm comprises at least one trainable neural network configured to analyze the one or more images;
wherein the at least one neural network is configured to:
receive the one or more images in raw data format as input;
use a hybrid algorithm to analyze the one or more images by subjecting the one or more images to semantic segmentation;
feed one or more features extracted from pixel-by-pixel segmented images as output variables to a second neural network; and
determine, by the second neural network from the one or more features extracted, one of the contamination classes as an output variable.

13. The forage harvester of claim 12, wherein the at least one neural network is configured to segment the one or more images pixel-by-pixel in that a respective class is assigned to each pixel; and
wherein the respective class is defined as a property saved in the memory unit.

14. The forage harvester of claim 13, wherein property soil is saved as one class and the property harvested material is saved as another class.

15. The forage harvester of claim 12, wherein the one or more features extracted comprise: segmentation ratio; number of polygons; average polygon size; standard deviation of a polygon size distribution; smallest polygon size; and largest polygon size.

16. The forage harvester of claim 12, wherein the second neural network includes an input layer, at least one hidden layer, and an output layer.

17. The forage harvester of claim 12, wherein the at least one neural network is configured to evaluate at least three successively received images of the flow of harvested material to determine the respective contamination class;
wherein the at least one neural network is configured to generate an output as a weighted mean value;
wherein one of the at least three successively received images of the flow of harvested material is selected for which the respective contamination class is to be determined; and
wherein the selected one of the at least three successively received images has a higher weighting than at least two other of the at least three successively received images when averaging.

18. The forage harvester of claim 1, further comprising the front attachment; and
wherein the image evaluation device, the driver assistance system, the front attachment, and the one or more work units form an automatic adjustment machine.

19. The forage harvester of claim 18, wherein the image evaluation device is configured to continuously analyze, using the machine learning algorithm, the one or more images of the flow of harvested material to determine a proportion of inorganic contaminants contained in the flow of harvested material; and
wherein the driver assistance system, based on the proportion of the inorganic contaminants or the indication of the proportion of the inorganic contaminants, is configured to autonomously and continuously modify the one or more settings of the front attachment or at least one of the one or more work units.
